(19) United States
(12) Patent Application Publication
(10) Pub. No.: US 2015/0245098 A1
(43) Pub. Date: Aug. 27, 2015

(54) METHODS, APPARATUS, AND USER INTERFACES FOR SOCIAL USER QUANTIFICATION

(71) Applicant: Telefonaktiebolaget L M Ericsson (publ), Stockholm (SE)

(72) Inventors: Kah Loon Liew, Mountain View, CA (US); Ignazio Moresco, San Francisco, CA (US); Saul Wyner, Sunnyvale, CA (US); Yvonne Ellefson, Ben Lomond, CA (US); Jessica Miller, Sunnyvale, CA (US)

(73) Assignee: Telefonaktiebolaget L M Ericsson (publ), Stockholm (SE)

(21) Appl. No.: 14/270,144

(22) Filed: May 5, 2014

Related U.S. Application Data
(60) Provisional application No. 61/943,501, filed on Feb. 24, 2014.

(51) Int. Cl. H04N 21/4788; H04N 21/61; H04N 21/258; H04N 21/45

(52) U.S. Cl. CPC H04N 21/4788; H04N 21/4532; H04N 21/6125; H04N 21/25891

(57) ABSTRACT

In an embodiment, an IPTV system provides social user quantifications by maintaining a user profile for a user that identifies a plurality of actions of the user with a respective plurality of video assets provided by the IPTV system. Each of the plurality of actions indicates that the user viewed, downloaded, recorded, scheduled to record, or rated the respective video asset. The IPTV system determines a social quantification value for the user based upon one or both of, the plurality of actions of the user within the IPTV system, and an additional plurality of actions by a plurality of other users of the IPTV system. The IPTV system causes an IPTV user interface to be presented to the user on a display of an electronic device that comprises a quantified self UI element that is based upon the social quantification value.

### CROSS-REFERENCE TO RELATED APPLICATIONS

This application claims the benefit of U.S. Provisional Application No. 61/943,501, filed Feb. 24, 2014, which is hereby incorporated by reference.

### FIELD

Embodiments of the invention relate to the field of Internet Protocol (IP) Television (IPTV) systems; and more specifically, to social user quantification in IPTV systems.

### BACKGROUND

IPTV is a multimedia delivery platform that utilizes a packet-based network infrastructure (e.g., broadband Internet access networks) to deliver video content to customers, typically as an alternative to delivery by traditional over-the-air television, satellite television, and cable television. A typical IPTV solution includes head-end video acquisition equipment for receiving television content, intermediate IPTV facilities (e.g., Ericsson Mediaroom™) including server platforms and associated IPTV middleware, networking devices (e.g., routers, switches) for content distribution between various nodes of the IPTV system, access nodes (e.g., very-high-bit-rate digital subscriber line (VDSL or VHDSL) or passive optical network (PON) equipment to enable high-bandwidth transport to and from the customer premises, and operator-controlled applications that manage the IPTV system and/or provide end-user IPTV applications.

Consumers (also referred to as users, end users, viewers, customers, subscribers) of IPTV services have traditionally had an isolated experience in their TV viewing. For example, to discuss a favorite television program, find out what new show the user's friends have discovered, or get movie recommendations from the user's friends or family, consumers have had to move away from the IPTV system and instead use email, social media, or verbal communication, which can be disruptive of the IPTV viewing experience, and/or require extended amounts of time and effort. Further, users have also lacked any insight into their viewing habits, such as what amounts and types of content they have viewed.

### SUMMARY

Embodiments of the invention provide relevant, concise, non-disruptive information to IPTV system users related to their television viewing, which can also be in relation the viewing habits of other people they know. Further, embodiments can provide users compelling quantifications using data visualization to easily communicate complex information. Thus, embodiments are able to take advantage of data analytics on television (e.g., broadcast, cable, premium), video on demand (VOD), over-the-top (OTT), and/or Internet streaming content usage, and can combine these analytics with awareness of social connections and usage by those contacts to present the information to the user, which may compel these users them to take further action or entice them with the joy of interesting data. Moreover, embodiments are able to directly integrate this analytical data into the viewing experience including live television.

According to an embodiment of the invention, a method in an Internet Protocol television (IPTV) system for providing social user quantifications is disclosed. The method includes maintaining a user profile for a user of the IPTV system. The user profile identifies a plurality of actions of the user with a respective plurality of video assets provided by the IPTV system. Each of the plurality of actions indicates that the user viewed, downloaded, recorded, scheduled to record, or rated the respective video asset. The method also includes determining a social quantification value for the user. This social quantification value is based upon the plurality of actions of the user within the IPTV system, and/or an additional plurality of actions by a plurality of other users of the IPTV system. The method also includes causing an IPTV user interface (UI) to be presented to the user on a display of an electronic device, which can be a television, personal computer, tablet, smartphone, or other electronic device. The IPTV user interface includes a quantified self UI element that is based upon the social quantification value.

According to an embodiment, a user equipment (UE) is described. The UE includes a network interface to be communicatively coupled with an Internet Protocol television (IPTV) system as well as a processor of the UE. The UE also includes a non-transitory computer-readable storage medium containing instructions which, when executed by the processor of the UE, cause the UE to present an IPTV user interface (UI) to a user of the IPTV system on a display. The IPTV user interface includes a quantified self UI element that is based upon a social quantification value for the user. The social quantification value is based upon one or both of a plurality of actions of the user within the IPTV system stored in a user profile of the IPTV system, and an additional plurality of actions by a plurality of other users of the IPTV system. The user profile identifies the plurality of actions of the user with a respective plurality of video assets provided by the IPTV system. Each of the plurality of actions indicates that the user viewed, downloaded, recorded, scheduled to record, or rated the respective video asset.

In an embodiment, a server computing device of an Internet Protocol television (IPTV) system is described. The server computing device includes one or more network interfaces to be communicatively coupled with a plurality of users of the IPTV system, and also communicatively coupled with a processor of the server computing device. The server computing device also includes a non-transitory computer-readable storage medium containing instructions which, when executed by the processor of the server computing device, cause the server computing device to maintain a user profile for a user of the plurality of users of the IPTV system. The user profile identifies a plurality of actions of the user with a respective plurality of video assets provided by the IPTV system. Each of the plurality of actions indicates that the user viewed, downloaded, recorded, scheduled to record, or rated the respective video asset. The instructions, when executed by the processor of the server computing device, also cause the server computing device to determine a social quantification value for the user based upon one or both of the plurality of actions of the user within the IPTV system, and an additional plurality of actions by other users of the plurality of users of the IPTV system. The instructions, when executed by the processor of the server computing device, also cause the server computing device to cause the one or more network interfaces to transmit data to a user equipment (UE) of the user to cause an IPTV user interface (UI) to be presented to the user on a display. The IPTV user interface comprises a quantified self UI element that is based upon the social quantification value.

### BRIEF DESCRIPTION OF THE DRAWINGS

The invention may best be understood by referring to the following description and accompanying drawings that are used to illustrate embodiments of the invention. In the drawings:

FIG. 1 illustrates a block diagram of a system including an IPTV system providing social user quantification according to an embodiment of the invention;

FIG. 2 illustrates an IPTV user interface including a quantified self UI element according to an embodiment of the invention;

FIG. 3 illustrates various exemplary quantified self UI elements according to an embodiment of the invention; and

FIG. 4 illustrates a flow for providing social user quantifications according to an embodiment of the invention; and

FIG. 5 illustrates a flow in a server end station for providing social user quantifications and a flow in a user equipment for providing social user quantifications according to embodiments of the invention.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist the code even when the electronic device is turned off, and while the electronic device is turned on that part of the code that is to be executed by the processor(s) of that electronic device is copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

IPTV systems may be configured to collect data indicating what “actions” their subscribers perform using the IPTV network. For example, an IPTV system may track user actions including a user choosing to watch, download, record, or indicate a preference for (e.g., “like” or “pin”) a video asset. However, the presentation of this information to users of these systems has been limited to providing recommendations (e.g., users who like a particular show may like a similar program, or users who watch one series tend to like another specific series) or an indication of which specific episodes of a series have already been watched. Aside from these recommendations, users today typically only find similar content that their friends or families watch/enjoy through social media applications or directly from person-to-person communications.

Methods, apparatuses, systems, and user interfaces for social user quantification are described herein. Embodiments of the invention take the abstract user action data of its users to determine and present socially quantified user information to allow its users to analyze their viewing habits/behaviors and/or discover new video asset content. In some embodiments, the action data of other users associated with a particular user (e.g., “friends” of the user such as those users that are directly connected with the user within an social network, other users located in a similar or different geographic area, other users having similar profile information or behavioral data, etc.) is analyzed, and may be presented to the user or compared against the user's own action data and then presented to the user. Accordingly, this configuration can take advantage of data analytics of a user's system usage combined with an awareness of the user's social connections and usage by those contacts to present the information to the user in the form of compelling quantifications with data visualizations, either compelling users to take further action or enticing them with the joy of interesting data.

In embodiments of the invention, the social user quantification service stores action data representing the viewing habits and system/content selections for individual users. However, this action database may also represent users in relation to subscriber accounts (e.g., for a household) so any combination of users within the house can be correlated and analyzed to create social user quantifications, when can then be presented to the user(s).

Furthermore, in some embodiments, users are able to “connect” their accounts (i.e., indicate an association) with accounts of other users of the system using, for example, a standard social media service or one provided by the IPTV system, though other methods of association exist. Following this connection of user accounts, the IPTV system in an embodiment is able to analyze the actions of the related users and then present, through simple text and/or infographics, information that is relevant and interesting to the user or multiple simultaneous household users of the television experience.

Accordingly, in an embodiment, a user can indicate another user or set of users as part of their circle of friends (through a connection to a social media application or via an operator-specific interface). Thus, the system is able to surface relevant data related to the users and their viewing habits as text and/or infographics, which serves to provide interesting and insightful information to the user as well as enable competitive and/or cooperative behavior between the users.

By way of example and not limitation, an IPTV system of the invention can be configured to present a quantified self UI element to a user to illustrate how the user's viewing of video assets compares to the viewing done by friends. For example, a quantified self UI element could indicate that 90% of the user's friends finished watching the final episodes of a television series (or season, package, etc.) and further indicate how many episodes the user has remaining. As another example, an IPTV system can indicate to a user, via a quantified self UI element, the top trending programs on live television among their friends, which can assist the user in deciding what might be interesting to watch at a particular moment in time. As another example, an IPTV system can present to a user, via a quantified self UI element, an indication that the user is a top viewer of a particular genre of video asset (e.g., drama, sports, action) among their friends (or among other users in an area, etc.). As another example, an IPTV system can indicate to a user, via a quantified self UI element, that the user can earn an opportunity for premium pay content from the operator at no cost by performing some number of actions, such as watching “2 more comedy genre movies,” etc.

In some embodiments, multiple users in a household are able to view video assets at the same time under a “shared” profile (known to the IPTV system via an authentication/login, an indication via remote control, body recognition (e.g., facial, vocal), mobile phone presence (e.g., through Near Field Communications or Bluetooth). In some embodiments with shared profiles, a blended experience can be offered that rolls up the same type of data but is instead tailored to multiple users. For example, if two members of a household like to watch documentaries together, the system can offer information relevant to that genre at times when they are watching together, and information relevant to a different genre of video asset when only one of those users is in the room (or is accessing IPTV services on another UE device, such as their personal mobile device)).

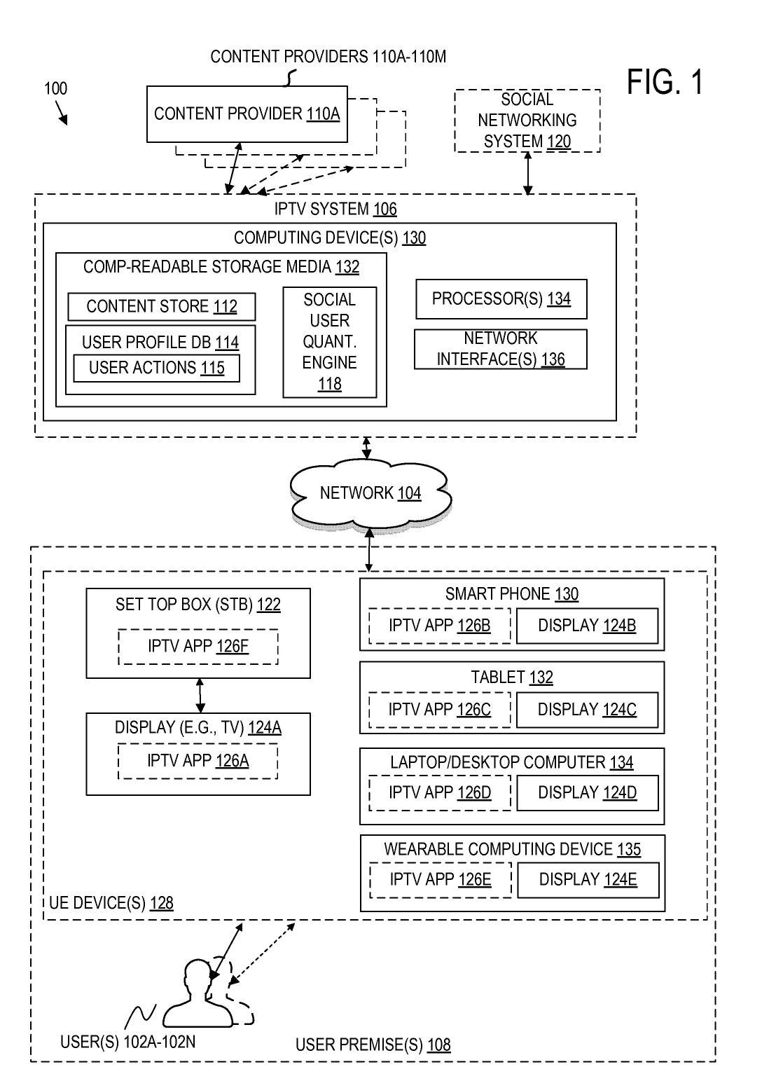

FIG. 1 illustrates a block diagram of a system 100 including an IPTV system 106 providing social user quantification according to an embodiment of the invention. The system 100 includes one or more content providers 110A-110M that provide video assets to the IPTV system 106 (or directly to UE devices 128), which are ultimately to be distributed/communicated with UE devices 128 (optionally at a user premise 108) via a communication network 104. The communication network 104 may include any type of data network, voice network, broadcast network, IP-based network, and/or wireless network facilitating communication of data and media content in any format. The communication network 104 can be implemented using any well-known type of network topology and/or communication protocol, and may be represented or otherwise implemented as a combination of two or more networks.

The UE devices 128 (or viewing systems, consumer devices, client devices, etc.) are electronic devices used by users 102A-102N to access video assets via IPTV system 106. A non-exhaustive set of UE devices 128 are illustrated herein and include a Set Top Box (STB) 122 which is connected to a display 124A (commonly a television, but can also be another type of monitor, projector, etc.). Other UE devices 128 include a smart phone 130, a tablet 132, a laptop or desktop computer 134, and a wearable computing device 135 (e.g., a smartwatch, digital eyewear, etc.)—each of which including a processor, computer-readable storage, a display 124B-124E respectively, and optionally an IPTV application 126B-126E respectively that executes to allow connectivity/interaction with the IPTV system 106. However, other UE devices can be implemented as any one or combination of wired and/or wireless device, as any form of television client device (e.g., STB 122, digital video recorder (DVR)), gaming device, computer device, portable computer device, consumer device, media device, communication device, video processing and/or rendering device, appliance device, mobile phone (e.g., cellular, Voice over IP (VoIP), WiFi, etc.), a portable media device (e.g., a personal/portable media player, handheld media player, etc.), and/or as any other type of device that is implemented to receive media content in any form of audio, video, and/or image data. A UE device (e.g., STB 133) may also be associated with a user 102A (i.e., a person) and/or an entity that operates the device.

The various UE devices (122, 130, 132, 134, 135) shown in system 100 may or may not include a respective display device (e.g., 124A-124E). A client device and display device together render and playback any form of audio, video, and/or image data. A display device (e.g., display 124A) can be implemented as any type of a television, high definition television (HDTV), Liquid Crystal Display (LCD), Light-Emitting Diode (LED) display, or similar display system. The various client devices (e.g., television, gaming, or computer devices) can also be associated with one or more input devices, such as a remote control device for accepting user-selectable input and selections to the television client device, a gaming controller for user-selectable inputs to the gaming device, and/or a keyboard and/or mouse input devices for user-selectable input to the UE device. The UE devices described herein can also be implemented with any differing combinations of other components such as one or more processors, communication components (e.g., network interfaces), memory components, and/or processing and control circuits. For example, a UE device may include network interfaces to receive video assets from IPTV system 106 and/or content providers 110A-110M, interfaces to receive broadcast and/or over-the-air inputs via which video assets can be received over the air. The UE devices may also include one or more tuners to tune television channels and/or data streams for display and viewing.

The UE devices and/or displays may optionally include IPTV applications (or “apps”) 126A-126F to assist in providing connectivity to the IPTV system 106. These IPTV apps 126, when executed by processors of the respective devices, may be configured to cause the respective devices to connect to the IPTV system 106 (e.g., using a set of network interfaces), send requests to the IPTV system 106 (e.g., for lists of video assets, for video assets themselves), receive responses from the IPTV system 106 (e.g., user interface (UI) elements from the IPTV system 106, video assets), present the user interfaces of the IPTV system 106 on the displays to the users, and/or display the video assets and any (optional) corresponding user interfaces (e.g., playback controls, additional video assets, advertising, etc.).

In the depicted embodiment of FIG. 1, the IPTV system 106 includes one or more computing devices 130 that include processor(s) 140, network interfaces 136 (for connecting to the content providers 110A-110M and/or social networking system 120 and/or UE devices 128), and computer-readable storage media 138. The computer-readable storage media 138, in this embodiment, stores a content store 112. The content store 112 may include copies of video assets, which may be provided by the content providers 110A-110M. The term “video asset” is generally used to refer to video or collection of images that may or may not include audio; however, the term “video asset” may also be used generically to refer to a piece of multimedia content, including but not limited to any type of audio, video, and/or image data received from any media content and/or data source. As described herein, a video asset can include recorded video content, video-on-demand (VOD) content, OTT video content, television content (e.g., “live” television, “broadcast” television), advertisements, commercials, music videos, movies, video clips, and other media content. Depending upon configuration, the IPTV system 106 may provide the video assets to the UE devices 128 via the network 104, but in some configurations the UE devices 128 use the network 104 to directly access video assets from content providers 110A-110M.

The content store 112 may also store other media content, metadata, interactive games, network-based applications, and/or any other content or data (e.g., program guide application data, user interface data, advertising content, closed captioning data, content metadata, search results and/or recommendations, etc.) for use by the IPTV system 106 and/or UE devices 128 when interacting with the IPTV system 106 and/or video assets.

The computer-readable storage media 138 may also include a user profile database (DB) 114. The user profile database, in an embodiment, includes user profile information including per-user contact information (e.g., address information, telephone/facsimile number(s), email addresses), financial information (e.g., bank account information, credit card information), payment information (e.g., payment history), and the like.

In an embodiment, the user profile information for a user (that data in the user profile) also includes information identifying one or more actions 115 of the user (e.g., user 102A). The set of user actions 115 include representations of actions that the user 102A has taken with respect to the IPTV system 106 and/or video assets. These user actions 115 may include one or more interactions that the user has had with a particular video asset, including viewing details about a video asset through the IPTV system 106, previewing the video asset, beginning to watch a video asset, stopping watching a video asset before the conclusion of the video asset, watching until the end of the video asset, downloading a video asset, recording a video asset or the configuration thereof, and/or indicating a preference for a video asset (e.g., “liking” the video asset, “disliking” the video asset, “pinning” the video asset). Of course, other actions may be possibly tracked by the IPTV system 106, and thus other actions in addition to these recited actions may be used in different embodiments of the invention.

In some embodiments of the invention, the IPTV system 106 is configured to implement and/or connect to one or more social networking systems 120 to allow users (e.g., 102A) to discover other users (e.g., users 102B-102N) of the IPTV system 106 that the user desires to be associated with. For example, the user 102A may access the IPTV system 106 by executing an IPTV app 126, providing that user's 102A username and/or password (or other authorization information) for a social network 120. The IPTV system 106 may then connect to the social networking system 120 to retrieve a list of the user's friends/contacts, and then determine the other users 102B-102N of the IPTV system 106 based upon this received list of the user's friends/contacts (e.g., by searching for users having a same name, geographic region, email address, phone number, etc.). As another specific example, the user 102A may access the IPTV system 106 by executing an IPTV app 126 and provide that user's 102A username and/or password (or other authorization information) for the social network 120 to retrieve a list of the user's friends/contacts and determine which of the user's friends/contacts are users of the IPTV system 106 or another TV-related provider or service through a shared setting and/or preference that may be part of the social network 120 and/or based on the social network posts of those friends/contacts. The associations between user 102A and the discovered “friend” users 102B-102N may be stored in user profile database 114. Of course, there are other ways for the IPTV system 106 to identify associated users/friends of a user, including but not limited to providing user search/browse functionalities within the IPTV system 106 itself, providing a social networking system 120 directly within the IPTV system 106 itself, etc.

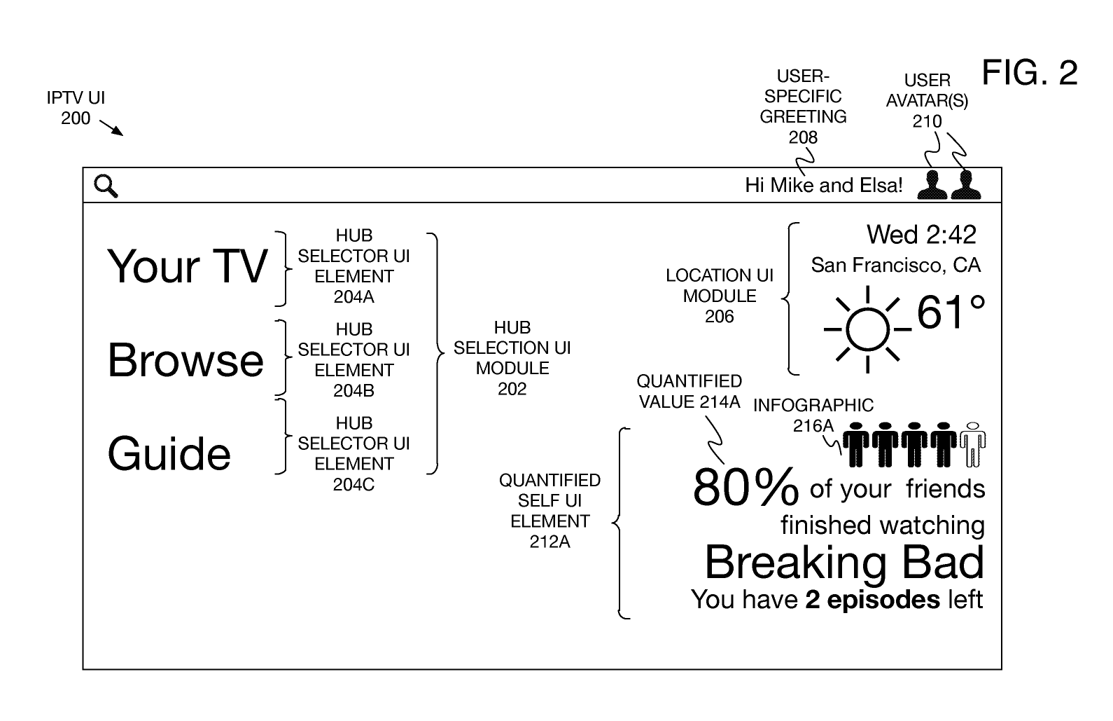

The computer-readable storage media 138 may also include a social user quantification engine 118 to provide social user quantifications to users via a quantified self UI element. FIG. 2 illustrates an IPTV user interface 200 including a quantified self UI element 212A according to an embodiment of the invention.

This exemplary IPTV UI 200 depicts a navigational menu overlay to be presented to a user at a display 124 (e.g., through IPTV App 126). This navigational menu overlay may be presented to the user upon a beginning of a video asset watching session, or may be presented to the user on demand in the midst (or termination) of presenting a video asset (e.g., such as when a user selects a particular “menu” or “home” button on a remote control).

The main landing interface further includes a top bar including a user specific greeting 208 as well as one or more avatars for currently “logged in” (or physically present) users. In some embodiments, only one user may be logged in, but in the depicted embodiment, two users are known to be present and are represented by two avatars within a “shared” profile. For example, FIG. 2 may illustrate what a television experience looks like when two users are watching a program and bring up the navigational menu overlay. The IPTV UI 200 also includes a location UI module 206 to present location-based information (or other, non-video asset information) to the users. In this example, the location UI module 206 knows a geographic location of the user (e.g., San Francisco) and reports the city name, the local time, a temperature at the city, and an icon (e.g., a sun) representing the current weather at the city.

This depicted IPTV UI 200 includes a hub selection UI module 202 allowing the user to select a “hub” for accessing video asset content. The hub selection UI module 202 includes a first hub selector UI element 204A entitled “Your TV,” a second hub selector UI element 204B entitled “Browse,” and a third hub selector UI element 204C entitled “Guide.” These hub selector UI elements 204, when selected by a user, enable the user to view information about video assets that exist, may exist, or will exist within the IPTV system 106.

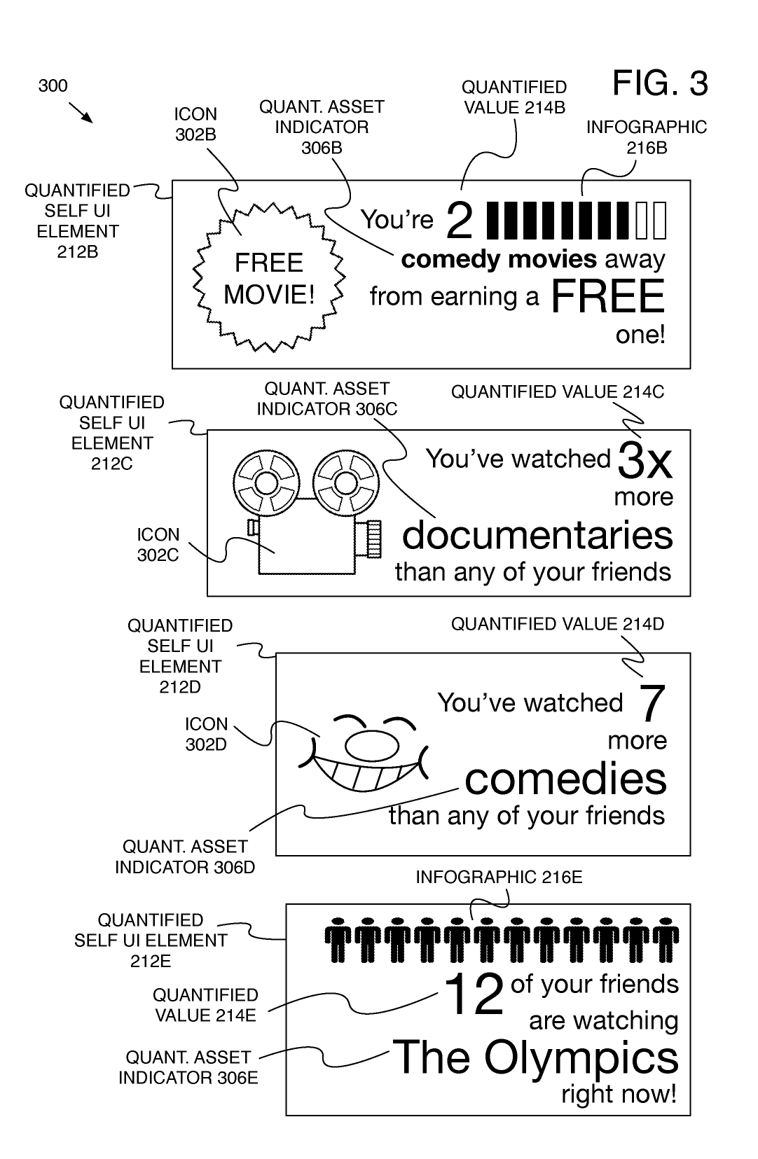

The IPTV UI 200 further includes a quantified self UI element 212A for presenting determined social user quantifications. In this example, the quantified self UI element 212A includes a quantified value 214A, an infographic 216A, and text/prose that further describes the quantification. The exemplary quantified self UI element 212A includes a quantified value 214A of “80%” (or 0.8), and the text indicates that “80% of your friends finished watching Breaking Bad” and that “you have 2 episodes left.” The infographic 216A includes five human icons, with four of the five icons shaded to provide an easily understood illustration of the quantified value 214A of 80% (as 4/5=0.8). Thus, this quantified self UI element 212A indicates that 80% of the user's friends have finished viewing all available episodes of the television series “Breaking Bad”, and that the user still has two of the episodes remaining to be watched. Of course, many other quantified self UI elements 212 may be generated with different quantified values 214, different infographics 216 (or no infographic at all), different text (or no text at all), and/or different UI elements (animations, icons, etc.); several further illustrative examples will be presented later herein with respect to FIG. 3.

However, the IPTV system 106 may generate this quantified self UI element 212A of FIG. 2 in the following manner. As described above, the IPTV system 106 for the user profile for “Mike and Elsa” determines a set of one or more other users of the IPTV system 106 to serve as a comparison group. In some embodiments, the comparison group includes the “friends” of the user, as determined from input by the user and/or information from a social networking system 120. In other embodiments, the comparison group may include a random selection of IPTV system 106 users, a set of all IPTV system 106 users (or all of those meeting a particular criteria), a set of family members of the user, a set of users in a particular geographic region/area, or another grouping of users.

Then, based upon an administrator input (e.g., an instruction from an administrator to generate “Breaking Bad”-related quantified self UI elements 212 for one or more users), the IPTV system 106 determines whether the user has viewed all of the episodes of the series based upon the saved set of actions (e.g., video assets watched) within the users user database record. If not, then the IPTV system 106 further determines the number of users of the comparison group have completed all episodes of the series (e.g., based upon the set of actions within each of those users' user database records). This number is calculated as a percentage, and thus, in this depicted example perhaps 80 of the user's 100 friends have completed the series. The IPTV system 106 further determines how many episodes the user has remaining to view of the series (e.g., two). When (or before) the user next causes the IPTV UI 200 to be displayed, the IPTV system 106 transmits data to the user's device to enable it to display the quantified self UI element 212A. In some embodiments, this transmitted data includes only some of the data (e.g., the quantified value 214A, an identifier of the name of the video asset, the value representing the number of episodes remaining) and the rest is completed via a template; however, in other embodiments the whole quantified self UI element 212A is sent by the IPTV system 106 (as individual parts—text, images, etc.—or just as an image representation). In some embodiments, if the user has not watched any episodes of the series, or if it is determined that the user would likely not enjoy that particular video asset, that particular quantified self UI element 212A may not be displayed and/or generated.

In some embodiments, the original decision of what video assets are to be included as part of quantified self UI elements 212 is automatic—upon the IPTV system 106 detecting the completion of a series (i.e., that all episodes of a season or series exist), that video asset is included as a candidate video asset. In some embodiments, the inclusion of the video asset occurs when one user of the comparison group of users completes an episode, season, and/or series of a video asset. Of course, other methodologies for identifying “interesting” video assets for quantified self UI elements 212 may be used, such as the use of machine learning techniques or detection algorithms for “trending” video assets.

In some embodiments, the quantified self UI element 212 “rotates” in one or more different UI elements after the expiry of certain periods of time. To say it another way, the information presented through the quantified self UI element 212 may in some embodiments periodically change after a certain amount of time.

Further, the type and content of quantified self UI element 212 may vary greatly. For example, FIG. 3 illustrates various exemplary quantified self UI elements 300 according to an embodiment of the invention. However, this set of exemplary quantified self UI elements is not exhaustive but rather is illustrative of some potential quantified self UI elements in various embodiments of the disclosed invention.

The first quantified self UI element 212B includes an icon 302B, a quantified asset indicator 306B, a quantified value 214B, an infographic 216B, and text/prose describing the quantification. In this example quantified self UI element 212B, the IPTV system 106 may run a promotion where any user that views a number (e.g., ten) of a certain genre of video assets (e.g., VOD), the user may then access another video asset of that genre for free. Thus, the IPTV system 106, based upon the set of actions of the user's user database record, determines that the user has viewed a particular number (e.g., ‘8’) of video assets (e.g., VOD movies) that are labeled as “comedies” that is less than a defined threshold number (e.g., ten) of video assets required for the promotion. In this example, the quantified value 214B of ‘2’ (e.g., 10−8=2) represents the number of comedy video assets required to be watched to satisfy the promotion, and the quantified asset indicator 306B of “comedies” represents the relevant genre of video asset. Further, the icon 302B includes a shape and text alerting the user to the possibility of a free movie, and the infographic 216B represents the quantified value 214B of ‘2’ and the progress of the user toward meeting the goal by using 10 bars, 8 of which are filled in a solid color. Of note is that this quantified self UI element 212B and quantified value 214B is based upon only the set of actions of the user, and is not based upon the set of actions of other users of the IPTV system 106 (whereas the previous quantified self UI element 212A of FIG. 1 was based upon both the set of actions of the user as well as the set of actions of other users).

The second quantified self UI element 212C includes an icon 302C representing a movie camera, a quantified asset indicator 306C of a relevant genre (e.g., “documentaries”), a quantified value 214B (“3×”), and text/prose describing the quantification. The second quantified self UI element 212C is based upon both the set of actions of the user as well as the set of actions of other users, and in an embodiment is presented when the current user has viewed more video assets of a genre than any of the users of the comparison set, although a similar quantification could be presented by comparing the user to the average value from the comparison set, for example. In this example, the quantified value 214C of “3×” indicates that the user has viewed more than 3 times the number of documentaries than any of the user's friends have watched.

A similar quantification to that of the second quantified self UI element 212D is presented in the third quantified self UI element 212D, which includes an icon 302D (e.g., a cartoon smiling face), a quantified value 214D (e.g., 7), and a quantified asset indicator 306D (e.g., “comedies”). The third quantified self UI element 212D is based upon both the set of actions of the user as well as the set of actions of other users, and in an embodiment is presented (or eligible for presentation) when the current user has viewed more video assets of a genre than any of the users of the comparison set, although a similar quantification could be presented by comparing the user to the average value from the comparison set, for example. In this example, the quantified value 214D of “7” indicates that the user has viewed 7 more video assets of the genre “comedy” than any of the comparison group of users.

The fourth quantified self UI element 212E includes a quantified value 214E (e.g., 12), a quantified asset indicator 306E (e.g., “The Olympics”, a name of a TV program), and an infographic 216E (e.g., twelve icons of people representing the quantified value 214E). The fourth quantified self UI element 212E is based upon the sets of actions of the other users, but not based upon the set of actions of current user. In some embodiments, the IPTV system 106 may be configured to identify occurrences when a threshold number or percentage of a set of comparison users (e.g., a user's set of friends) are all currently performing (or have previously performed) a shared action (e.g., watching a same video asset, scheduling a video asset to be recorded, stopping a video asset early before its end, etc.). In this example quantified self UI element 212E, the IPTV system 106 identified (based upon a set of actions of the comparison users) that twelve (i.e., the quantified value 214E) of the user's friends were currently watching “The Olympics” (i.e., a video asset represented by the quantified asset indicator 306E). Interestingly, this fourth quantified self UI element 212E illustrates an interesting scenario where the live television viewing habits of users may be collected and shared with fellow users and potentially create “trending” events with large numbers of users detecting the popularity of a live program, and then in turn “tuning in” to the program, thereby creating even larger swells of viewership and further recommendations to other users.

The quantified self UI elements 214 depicted herein within FIG. 1 and FIG. 2 are merely illustrative of embodiments of the invention and thus are not to be read as limiting. In other embodiments, other quantified self UI elements 214 may be generated based upon one or more of the set of actions of the user and the sets of actions of the comparison user set.

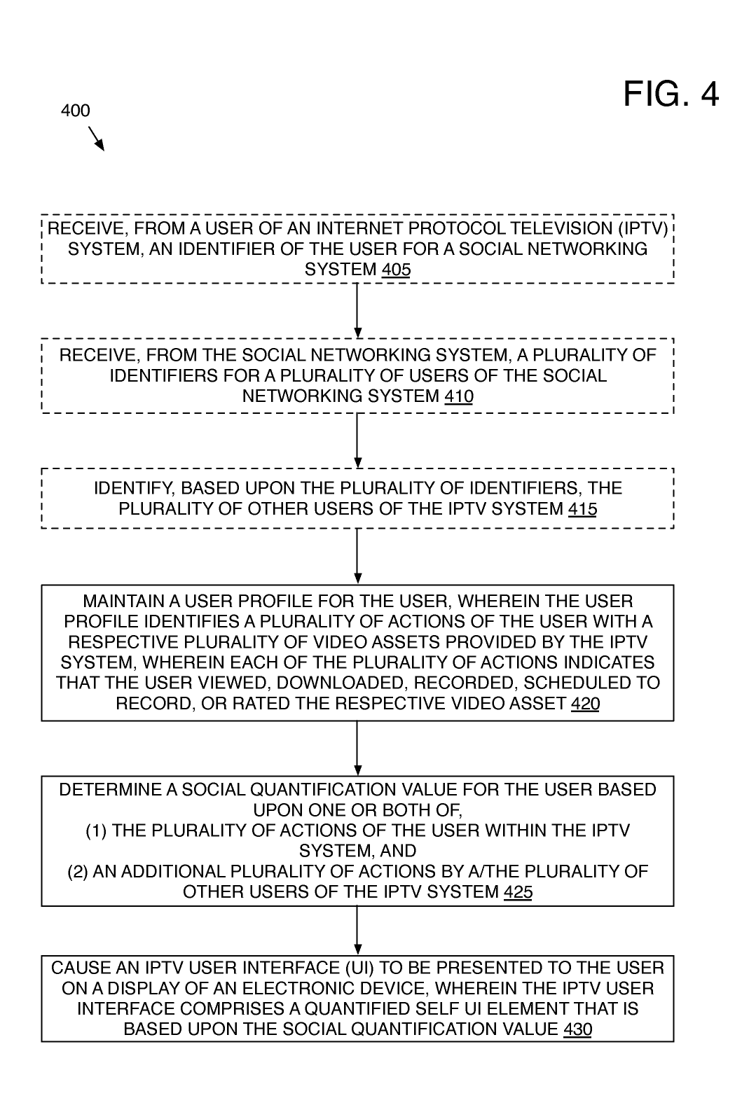

FIG. 4 illustrates a flow 400 for providing social user quantifications according to an embodiment of the invention. The operations of this and other flow diagrams will be described with reference to the exemplary embodiments of the other diagrams. However, it should be understood that the operations of the flow diagrams can be performed by embodiments of the invention other than those discussed with reference to these other diagrams, and the embodiments of the invention discussed with reference to these other diagrams can perform operations different than those discussed with reference to the flow diagrams.

According to an embodiment, one or more of three optional blocks are performed as part of determining a comparison user set to be analyzed against the intended user. In an embodiment, then, the flow 400 includes at block 405 receiving, from a user of an Internet Protocol television (IPTV) system, an identifier of the user for a social networking system. In an embodiment, the social networking system is provided by the IPTV system, but in other embodiments the social networking system is external to and not controlled by the IPTV system. In various embodiments, the received identifier is a username, email address, telephone number, or other identifying piece of information used by the user with the social networking system.

In an embodiment, the flow 400 includes at block 410 receiving, from the social networking system, a plurality of identifiers for a plurality of users of the social networking system. In some embodiments, transmitting a request for the plurality of users precedes this block 410, and the request may include the identifier of the user received at block 405. In block 410, in an embodiment, the plurality of identifiers includes one or more of usernames, email addresses, names, and/or telephone numbers of the plurality of users.

In an embodiment, the flow 400 includes at block 415 identifying, based upon the plurality of identifiers, the plurality of other users of the IPTV system. In an embodiment, this identifying includes searching a plurality of user profile records of a user profile database 114 for data matching the plurality of identifiers. For example, in an embodiment where each of the plurality of identifiers is an email address, the user profile records of the user profile database 114 may be searched for matching email addresses. In an embodiment, this identifying further includes updating a list of associated users within the user profile record of the first user to thereby associate the user with these identified other users of the IPTV system.

The flow 400 includes, at block 420, maintaining a user profile for the user. The user profile identifies a plurality of actions of the user with a respective plurality of video assets provided by the IPTV system, and each of the plurality of actions indicates that the user viewed, downloaded, recorded, scheduled to record, or rated the respective video asset. However, in other embodiments, different actions are possible and may be used, which are well known to those of skill in the art.

At block 425, the flow 400 includes determining a social quantification value for the user. This determination may be based upon one or both of: (1) the plurality of actions of the user within the IPTV system, and (2) an additional plurality of actions by the plurality of other users of the IPTV system. The plurality of other users of the IPTV system may be determined by blocks 405-415 (as illustrated above) or via another process (e.g., selecting all users of the IPTV system, selecting users in a same geographic region as the user, selecting users sharing a particular demographic with the user, etc.).

At block 430, the flow 400 includes causing an IPTV user interface to be presented to the user on a display of an electronic device. The IPTV user interface includes a quantified self UI element that is based upon the social quantification value. In an embodiment, the IPTV user interface includes the social quantification value, and one or more of text, an icon, an infographic, and a quantified asset indicator.

In an embodiment, this depicted flow 400 is performed by the IPTV system 106 (e.g., by social user quantification engine 118), and in another embodiment the depicted flow 400 is performed by both the IPTV system 106 (e.g., by social user quantification engine 118) and one or more UE devices 128 acting in cooperation with the IPTV system 106. However, other embodiments may utilize more or fewer elements to perform the flow 400.

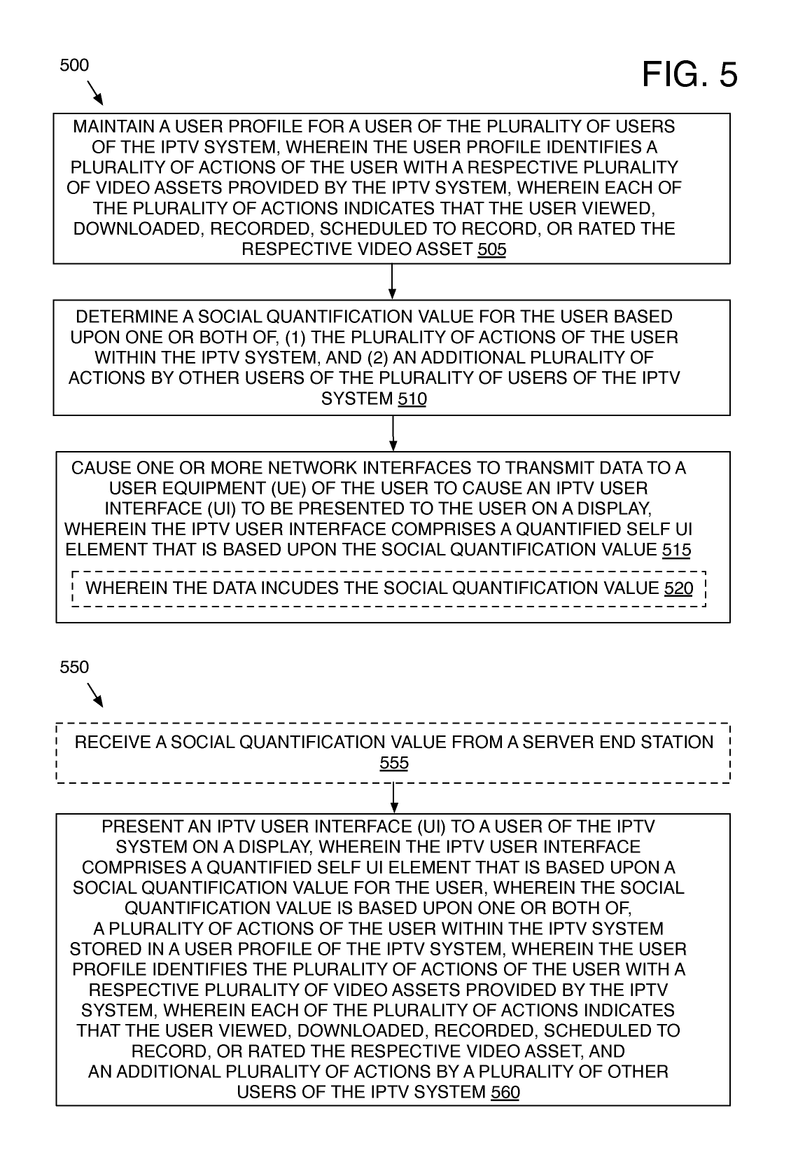

FIG. 5 illustrates a flow 500 in a server end station (e.g., computing devices 130) for providing social user quantifications and a flow 550 in a user equipment (e.g., UE devices 128) for providing social user quantifications according to embodiments of the invention.

In an embodiment, the social user quantification engine 118 of the computing devices 130 performs flow 500. Flow 500 includes, at block 505, maintaining a user profile for a user of the plurality of users of the IPTV system. The user profile identifies a plurality of actions of the user with a respective plurality of video assets provided by the IPTV system. Each of the plurality of actions indicates that the user viewed, downloaded, recorded, scheduled to record, or rated the respective video asset. At block 510, the flow 500 includes determining a social quantification value for the user based upon one or both of: (1) the plurality of actions of the user within the IPTV system, and (2) an additional plurality of actions by other users of the plurality of users of the IPTV system. At block 515, the flow 500 includes causing one or more network interfaces to transmit data to the UE of the user to cause an IPTV UI to be presented to the user on a display. The IPTV UI includes a quantified self UI element that is based upon the social quantification value. In an embodiment, the data that is transmitted in block 515 includes the social quantification value 520. In an embodiment, the server end station comprises one or more computing devices 130 of the IPTV system 106.

In an embodiment, a UE device 128 performs flow 550. Flow 550 includes, at block 555, receiving a social quantification value from a server end station. In an embodiment, this social quantification value is received at a set of one or more network interfaces from a server end station (e.g., computing devices 130) of an IPTV system 106.

At block 560, the flow 550 includes presenting an IPTV user interface (UI) to a user of the IPTV system on a display. The IPTV UI comprises a quantified self UI element that is based upon the social quantification value for the user. The social quantification value is based upon one or both of: (1) a plurality of actions of the user within the IPTV system stored in a user profile of the IPTV system, and (2) an additional plurality of actions by a plurality of other users of the IPTV system. The user profile identifies the plurality of actions of the user with a respective plurality of video assets provided by the IPTV system. Each of the plurality of actions indicates that the user viewed, downloaded, recorded, scheduled to record, or rated the respective video asset.

While this embodiment has been described in relation to an IPTV system, alternative embodiments could instead be utilized for other systems having a plurality of users consuming or interacting with media content or even other entities. For example, embodiments of the invention work in a video gaming service, a music service, a video service, an image service, a business review service, rating services, an online storefront, etc.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

Additionally, while the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method in an Internet Protocol television (IPTV) system for providing social user quantifications, the method comprising:
maintaining a user profile for a user of the Internet Protocol television (IPTV) system, wherein the user profile identifies a plurality of actions of the user with a respective plurality of video assets provided by the IPTV system, wherein each of the plurality of actions indicates that the user viewed, downloaded, recorded, scheduled to record, or rated the respective video asset;
determining a social quantification value for the user based upon one or both of,
the plurality of actions of the user within the IPTV system, and
an additional plurality of actions by a plurality of other users of the IPTV system; and
causing an IPTV user interface (UI) to be presented to the user on a display of an electronic device, wherein the IPTV user interface comprises a quantified self UI element that is based upon the social quantification value.

2. The method of claim 1, wherein:
said determining the social quantification value is based upon the additional plurality of actions of the other users; and
said determining the social quantification value comprises determining a number of or a percentage of the plurality of other users that have viewed, downloaded, recorded, scheduled to record, or rated a video asset.

3. The method of claim 2, wherein the quantified self UI element, when selected by the user, causes either the IPTV UI to change to present information describing the video asset or the display to present the video asset.

4. The method of claim 2, wherein the video asset comprises a plurality of episodes of a TV series, and wherein the social quantification value is the number of or the percentage of the plurality of other users that have viewed all of the plurality of episodes of the TV series.

5. The method of claim 4, wherein the quantified self UI element displays the social quantification value and a name of the TV series.

6. The method of claim 1, wherein:
said determining the social quantification value is based upon the plurality of actions of the user and the additional plurality of actions of the other users; and
said determining the social quantification value comprises,
determining a number of the plurality of video assets, which are identified by the plurality of actions of the user of the user profile, that belong to a genre, and
determining, for the plurality of other users of the IPTV system, a plurality of numbers, wherein each of the plurality of numbers is a count of a respective plurality of video assets identified by the respective additional plurality of actions of the respective other user that belong to the genre;
wherein the social quantification value is based upon the number and one or more of the another numbers determined for the plurality of other users.

7. The method of claim 6, wherein:
the social quantification value comprises,
a difference between the number and the one or more of the plurality of another numbers, or
a multiple of the number with respect to the one or more of the plurality of another numbers; and
the quantified self UI element displays the social quantification value and a name of the genre.

8. The method of claim 1, wherein:
said determining the social quantification value is based upon the plurality of actions of the user;
said determining the social quantification value is based upon determining a number of the plurality of video assets, which are identified by the plurality of actions of the user of the user profile, that belong to a genre; and
the quantified self UI element displays the social quantification value and a name of the genre.

9. The method of claim 1, wherein the quantified self UI element displays a number representing the social quantification value, text, and an infographic based upon the number representing the social quantification value.

10. The method of claim 1, further comprising:
receiving, from the user, an identifier of the user for a social networking system;
receiving, from the social networking system, a plurality of identifiers for a plurality of users of the social networking system, wherein the plurality of users of the social networking system includes the plurality of others users of the IPTV system; and
identifying, based upon the plurality of identifiers, the plurality of other users of the IPTV system.

11. A user equipment (UE), comprising:
a network interface to be communicatively coupled with an Internet Protocol television (IPTV) system and a processor of the UE;
a non-transitory computer-readable storage medium containing instructions, which when executed by the processor of the UE, cause the UE to,
present an IPTV user interface (UI) to a user of the IPTV system on a display, wherein the IPTV user interface comprises a quantified self UI element that is based upon a social quantification value for the user, wherein the social quantification value is based upon one or both of,
a plurality of actions of the user within the IPTV system stored in a user profile of the IPTV system, wherein the user profile identifies the plurality of actions of the user with a respective plurality of video assets provided by the IPTV system, wherein each of the plurality of actions indicates that the user viewed, downloaded, recorded, scheduled to record, or rated the respective video asset, and
an additional plurality of actions by a plurality of other users of the IPTV system.

12. The UE of claim 11, wherein when the quantified self UI element, when selected by the user, causes either the IPTV UI to change to present information describing the video asset or the display to present the video asset.

13. The UE of claim 11, wherein the quantified self UI element displays a number representing the social quantification value, text, and an infographic based upon the number representing the social quantification value.

14. The UE of claim 11, wherein the social quantification value comprises a percentage of the plurality of other users of the IPTV system that have viewed a video asset.

15. The UE of claim 11, wherein the social quantification value comprises a number of or a percentage of the plurality of other users of the IPTV system that are currently viewing a video asset.

16. The UE of claim 11, wherein the social quantification value comprises:
a difference between,
a number of the plurality of the actions of the user that are for video assets of a genre, and
another number of the additional plurality of actions of one or more of the plurality of other users that are for video assets of the genre; or
a multiple of the number with respect to the another number.

17. A server computing device of an Internet Protocol television (IPTV) system, comprising:
one or more network interfaces to be communicatively coupled with a plurality of users of the IPTV system and a processor of the server computing device; and
a non-transitory computer-readable storage medium containing instructions, which when executed by the processor of the server computing device, cause the server computing device to:
maintain a user profile for a user of the plurality of users of the IPTV system, wherein the user profile identifies a plurality of actions of the user with a respective plurality of video assets provided by the IPTV system, wherein each of the plurality of actions indicates that the user viewed, downloaded, recorded, scheduled to record, or rated the respective video asset,
determine a social quantification value for the user based upon one or both of,
the plurality of actions of the user within the IPTV system, and
an additional plurality of actions by other users of the plurality of users of the IPTV system; and
cause the one or more network interfaces to transmit data to a user equipment (UE) of the user to cause an IPTV user interface (UI) to be presented to the user on a display, wherein the IPTV user interface comprises a quantified self UI element that is based upon the social quantification value.

18. The server computing device of claim 17, wherein:
the instructions cause the server computing device to determine the social quantification value based upon the additional plurality of actions of the other users; and
the server computing device, to determine the social quantification value, is to determine a number of or a percentage of the plurality of other users that have viewed, downloaded, recorded, scheduled to record, or rated a video asset.

19. The server computing device of claim 17, wherein:
the instructions cause the server computing device to determine the social quantification value based upon the plurality of actions of the user and the additional plurality of actions of the other users; and
the server computing device, to determine the social quantification value, is to,
determine a number of the plurality of video assets, which are identified by the plurality of actions of the user of the user profile, that belong to a genre, and
determine, for the plurality of other users of the IPTV system, a plurality of numbers, wherein each of the plurality of numbers is a count of a respective plurality of video assets identified by the respective additional plurality of actions of the respective other user that belong to the genre;
wherein the social quantification value is to be based upon the number and one or more of the another numbers determined for the plurality of other users

20. The server computing device of claim 17, wherein:
the instructions cause the server computing device to determine the social quantification value based upon the plurality of actions of the user;
the server computing device, to determine the social quantification value, is to determine a number of the plurality of video assets, which are identified by the plurality of actions of the user of the user profile, that belong to a genre; and
the quantified self UI element is to display the social quantification value and a name of the genre.
